(19) United States
(12) Patent Application Publication
(10) Pub. No.: US 2010/0139026 A1
(43) Pub. Date: Jun. 10, 2010

(54) Wiper Blade Spoiler Assembly

(75) Inventor: Shu-Lan Ku, Taipei Hsien (TW)

Correspondence Address: Brinks Hofer Gilson & Lione/Ann Arbor, 524 South Main Street, Suite 200, Ann Arbor, MI, 48104, US

(73) Assignee: Chin Pech Co., Ltd., Hsin-Chuang City (TW)

(21) Appl. No.: 12/631,454

(22) Filed: Dec. 4, 2009

Related U.S. Application Data
(60) Provisional application No. 61/119,742, filed on Dec. 4, 2008.

(51) Int. Cl. B60S 1/32

(52) U.S. Cl. 15/250.201

(57) ABSTRACT

A wiper blade assembly includes a wiper blade and a spoiler assembly. The wiper blade includes a wiper strip. The spoiler assembly defines a internal opening for receiving a first portion of the wiper strip. The spoiler assembly is slidingly and removably mounted to the wiper blade by inserting the first portion of the wiper strip in the internal opening.

### CROSS-REFERENCE TO RELATED APPLICATIONS

This application claims priority of U.S. Provisional Application No. 61/119,742, filed on Dec. 4, 2008 and entitled “Wiper Blade Spoiler Assembly,” the disclosure of which is incorporated herein by reference in its entirety.

### FIELD

The present disclosure relates to wiper blade assemblies, and more particularly to wiper blade spoiler assemblies for deflecting wind to reduce wind resistance.

### BACKGROUND

A wiper blade assembly may include a spoiler for deflecting wind to reduce wind resistance. Typically, a spoiler is mounted directly on a metal support element of the wiper blade. The spoiler includes locking features for engaging the support element and securing the spoiler to the support element. The structures of the spoilers are specific to the types and sizes of the support elements due to the engagement between the locking features and the support elements. Therefore, different spoilers require different molding tools. The molding tools require high precision to ensure that the locking features can properly secure the spoiler to the support element as designed, resulting in increased manufacturing costs.

The locking features of the typical spoilers are generally provided proximate longitudinal ends of the support element to lock or snap fit with the longitudinal ends of the support element. The support element generally has an extended length with a predetermined curvature. The spoiler may not be properly secured in a middle portion of the support element. Glue may be used to improve mounting of the spoilers to the wiper blades. Therefore, mounting the spoilers to the wiper blades is relatively difficult and time-consuming.

### SUMMARY

In one form, a wiper blade assembly includes a wiper blade and a spoiler assembly. The wiper blade includes a wiper strip. The spoiler assembly defines a internal opening for receiving a first portion of the wiper strip. The spoiler assembly is slidingly and removably mounted to the wiper blade by inserting the first portion of the wiper strip in the internal opening.

In another form, a wiper blade assembly includes an elastic spring support element, a wiper strip, a spoiler body, and a mounting piece. The support element defines an upper surface, a bottom surface, and an elongated slot extending along a longitudinal axis of the support element. The wiper strip is inserted through the elongated slot and includes a first portion disposed proximate the upper surface. The first portion includes a base contacting the upper surface and a head. The head and the base define a notch therebetween. The mounting piece is slidingly mounted around the head of the wiper strip. A portion of the mounting piece is inserted into the notch. The spoiler body includes a base portion proximate the support element and a wind deflection portion. The base portion is disposed between the wind deflection portion and the base portion. The base portion defines a internal opening for receiving the mounting piece. The wind deflection portion defines a curved surface. The mounting piece and the spoiler body are made of different materials.

In still another form, a spoiler assembly includes a base portion and a wind deflection portion. The base portion defines a internal opening for removably and slidingly engaging a wiper strip of a wiper blade. The wind deflection portion is disposed on the base portion for deflecting wind.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a wiper blade assembly according to the teachings of the present disclosure;

FIG. 2 is a partial exploded view of the wiper blade assembly of FIG. 1;

FIG. 3 is a cross-sectional view of a wiper blade of a wiper blade assemblies according to the teachings of the present disclosure;

FIG. 4 is a top view of a support element of the wiper blade of FIG. 3;

FIG. 5 is a cross-sectional view of a wiper strip of the wiper blade of FIG. 4;

FIG. 6 is a top perspective view of a bridge base of a wiper blade assembly according to the present disclosure;

FIG. 7 is a bottom perspective view of a bridge base of a wiper blade assembly according to the present disclosure;

FIG. 8 is an end view of a bridge base of a wiper blade assembly according to the present disclosure;

FIG. 9 is a cross-sectional view of a wiper blade assembly according to the present disclosure, taken along line A-A of FIG. 1;

FIG. 10 is a cross-sectional view of a mounting piece of a wiper blade assembly according to the present disclosure;

FIG. 11 is a view of the wiper blade assembly according to the present disclosure, showing mounting of a spoiler assembly to a wiper blade;

FIG. 12 is a top view of a wiper blade assembly after the spoiler assemblies are mounted and before the adaptor assembly is mounted;

FIG. 13 is a top perspective view of an end cap of a wiper blade assembly according to the present disclosure;

FIG. 14 is a bottom perspective view of an end cap of a wiper blade assembly according to the present disclosure;

FIG. 15 is a view of an enlarged portion A of FIG. 14;

FIG. 16 is a top view of a portion of the wiper blade assembly, showing an end cap assembled to an end of the support element;

FIG. 17 is a cross-sectional view of a wiper blade assembly according to the present disclosure, taken along line B-B of FIG. 1; and

FIG. 18 is a cross-sectional view of another variant of a wiper blade assembly according to the teachings of the present disclosure.

### DETAILED DESCRIPTION

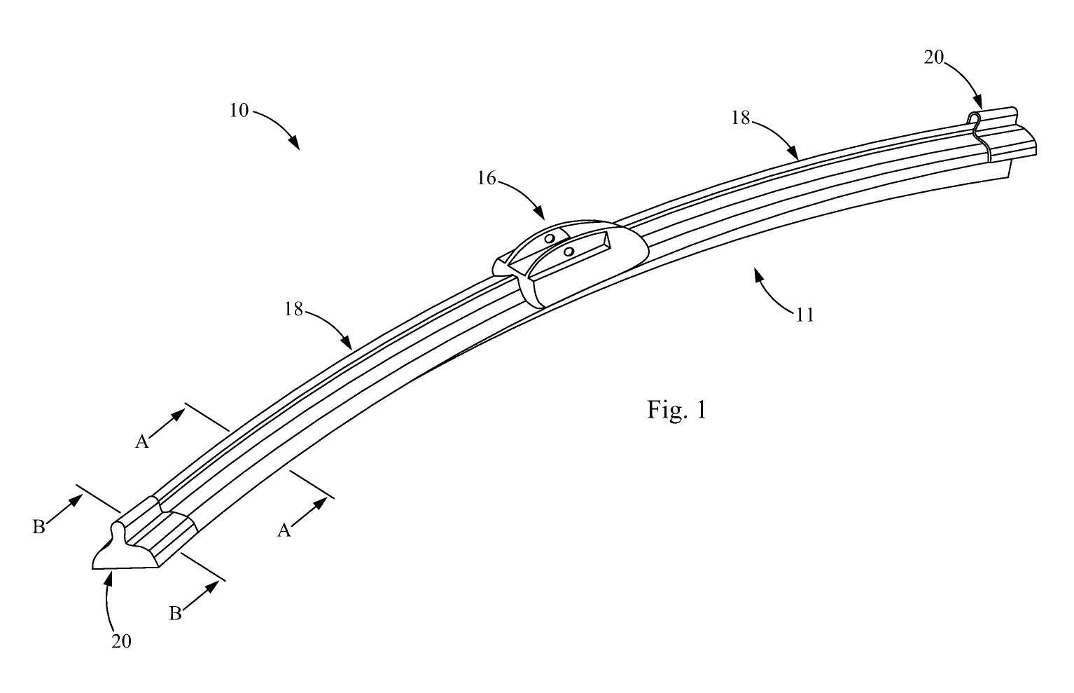

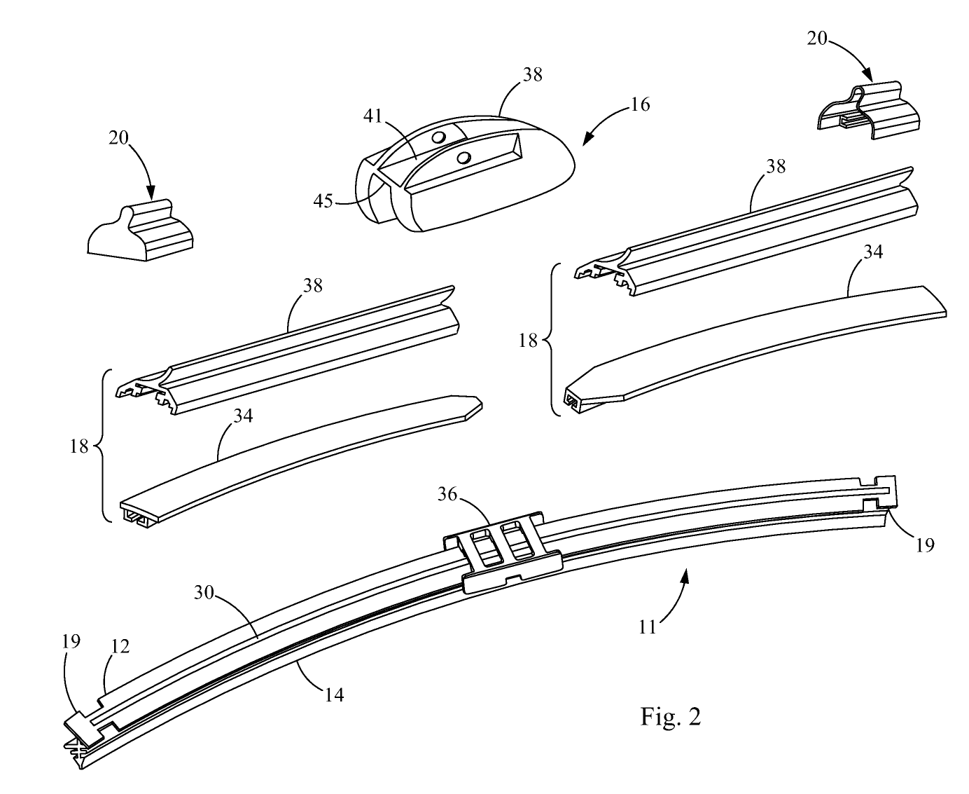

Referring to FIGS. 1 and 2, a wiper blade assembly 10 in accordance with the teachings of the present disclosure includes a wiper blade 11, an adaptor assembly 16, a pair of spoiler assemblies 18, and a pair of end caps 20. The adaptor assembly 16 is mounted to a middle portion of the wiper blade 11 through a bridge base 36. The spoiler assemblies 18 are disposed on both sides of the adaptor assembly 16. The end caps 20 are provided at two longitudinal ends 19 of the wiper blade 11 for securing the spoiler assemblies 18 on the wiper blade 11. The spoiler assemblies 18 each include a mounting piece 34 and a spoiler body 38. The wiper blade 11 includes an elastic spring support element 12 and a rubber wiper strip 14 attached to the support element 12.

The adaptor assembly 16 includes an adaptor housing 38 and an adapting member 41 received inside the adaptor housing 38. The adaptor housing 38 is mounted on the bridge base 36 by a snap-on relationship. A wiper arm (not shown) may be connected to the wiper blade 11 by connecting the wiper arm to the adapting member 41. The adaptor assembly 16 is removably mounted on the bridge base 36 and may have a configuration different from that shown in FIG. 2 to be adapted for other types of wiper arms. Using a bridge base 36 to connect an adaptor assembly 16 to a wiper blade 11 and using an adaptor assembly to connect a wiper arm to the wiper blade have been disclosed in co-pending application Ser. No. 11/498,960, entitled “Windshield Wiper Bridge Base Assembly”, the disclosure of which is incorporated herein by reference in its entirety.

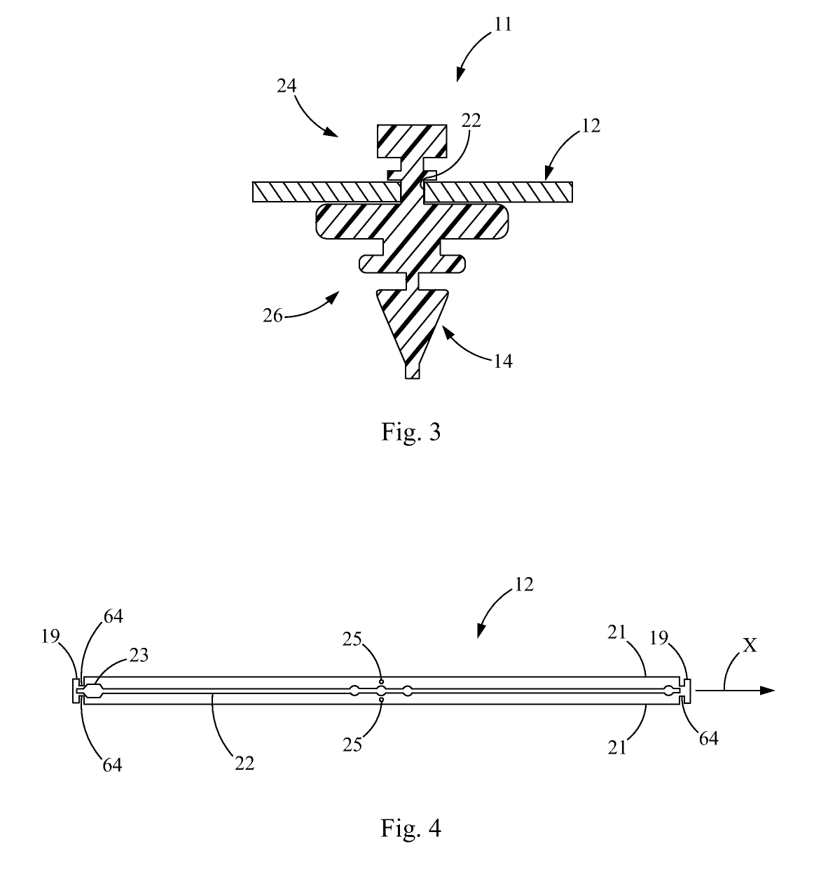

Referring to FIGS. 3 to 5, the support element 12 includes a curved and elongated stripe and defines an elongated slot 22 extending along a longitudinal axis X of the support element 12. The wiper strip 14 may be made of rubber and is inserted through the elongated slot 22. The support element 12 has two positioning holes 25 for positioning the bridge base 36. An insertion hole 23 may be formed at one or both longitudinal ends 19 of the support element 12 to facilitate insertion of the wiper strip 14 in the elongated slot 22. The longitudinal ends 19 of the support element 12 define cutouts 64 along longitudinal edges 21.

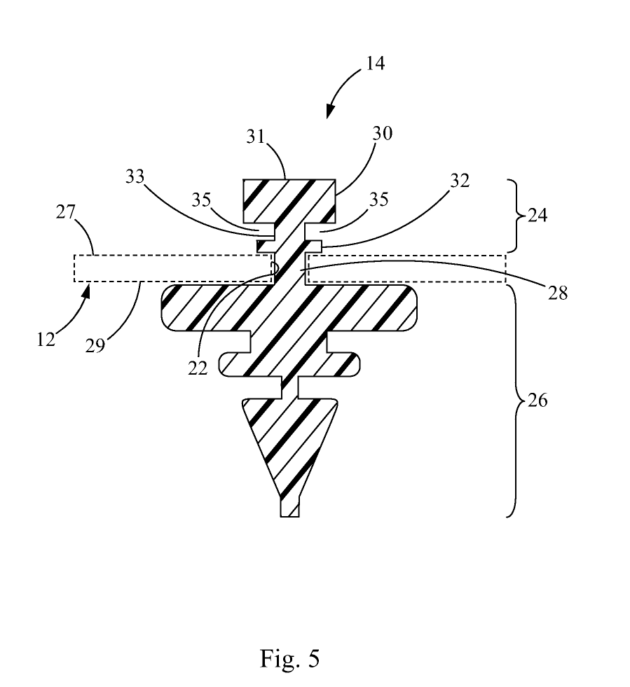

As clearly shown in FIG. 5, the wiper strip 14 includes an upper portion 24 disposed proximate an upper surface 27 of the support element 12 and a lower portion 26 disposed proximate a bottom surface 29 of the support element 12. The upper portion 24 and the lower portion 26 are connected by a neck portion 28 which is disposed in the elongated slot 22 of the support element 12. The upper portion 24 includes a head 30, a base 32, and a connecting portion 33 between the head 30 and the base 32. A notch 35 is formed between the head 30 and the base 32 on each side of the connecting portion 33. The head 30 has a top flat surface 31.

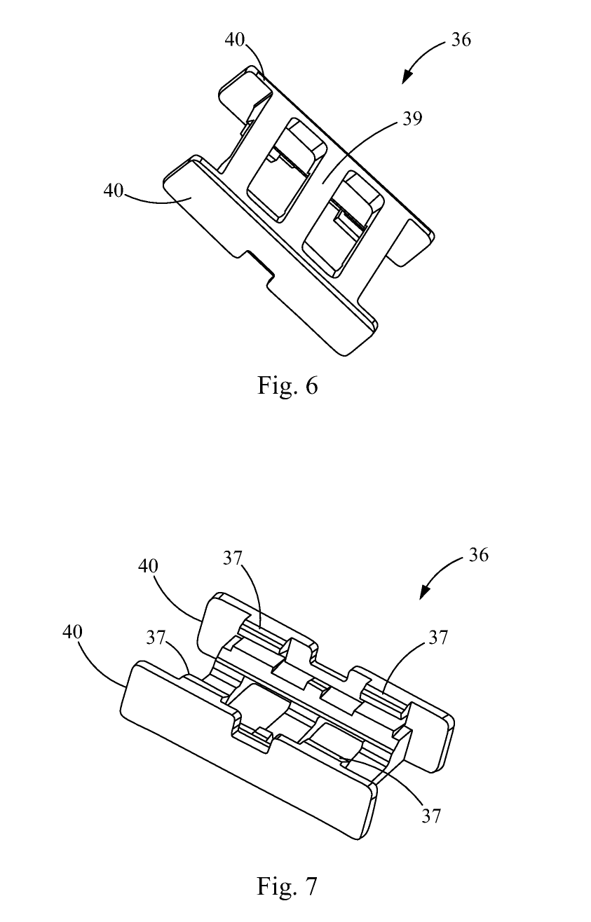

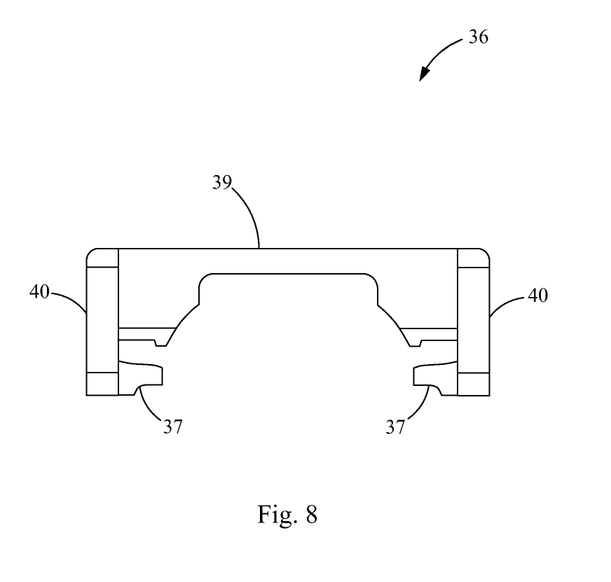

Referring to FIGS. 6 to 8, the bridge base 36 includes a pair of side rails 40 disposed on longitudinal edges 21 of the support element 12. The bridge base 36 may be securely mounted on the support element 12 of the wiper blade 11 by any conventional means, such as welding and clamping. For example, the bridge base 36 may define at least one clamping leg 37 for engaging the bottom surface 29 of the support element 12 to secure the bridge base 36 on the support element 12. The bridge base 36 has a flat top surface 39 and thus has a low profile. When the adaptor assembly 16 is mounted on the bridge base 36, the adaptor housing 38 engages the side rails 40 of the bridge base 36 in a snap-fit manner. While not shown in the drawings, the bridge base 36 may have extension arms extending upwardly from the top surface 39 and/or the side rails 40 of the bridge base 36. The extension arms may engage an inner wall of the adaptor housing 38 to increase contact area between the adaptor housing 38 and the bridge base 36 and to improve connection between the adaptor housing 38 and the bridge base 36.

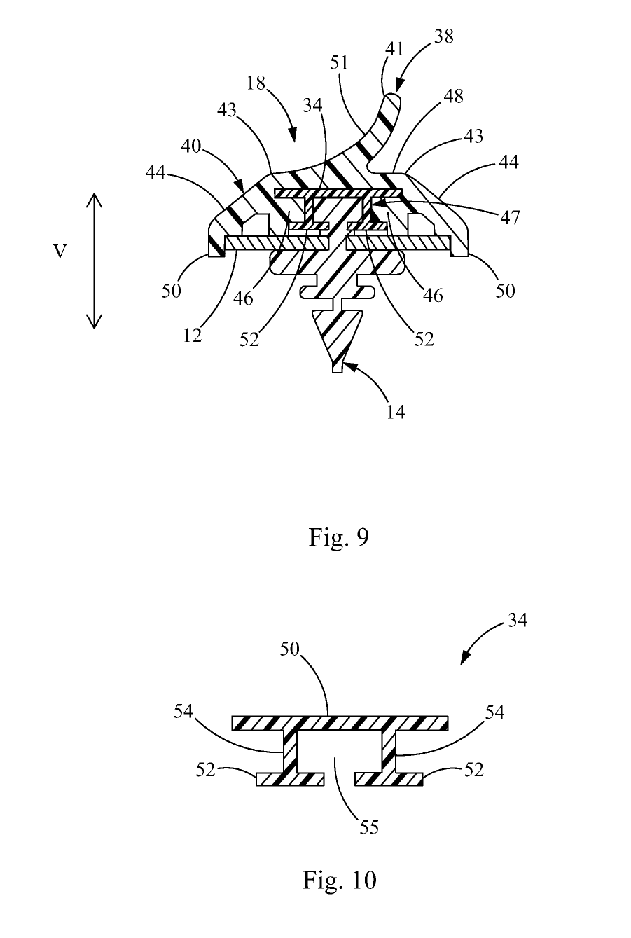

Referring to FIG. 9, the spoiler assemblies 18 each includes a mounting piece 34 and a spoiler body 38 slidingly mounted on the mounting piece 34. The mounting piece 34 is slidingly mounted around the head 30 of the wiper strip 14. The spoiler body 38 includes a base portion 40 and a wind deflection portion 42. The wind deflection portion 42 extends upwardly from the base portion 40 and defines a curved surface 51 as the wind deflection surface for deflecting wind.

The base portion 40 is substantially symmetric relative to the longitudinal axis X of the support element 12 and has a substantially trapezoid shape. The base portion 40 includes a internal opening 47 for receiving the mounting piece 34 and the head 30 of the wiper strip 14 therein. The internal opening 47 guides the mounting piece 34 and the head 30 of the wiper strip 14 to move along the longitudinal axis X of the support element 12 and prevents the spoiler assembly 18 from moving along a vertical direction of the wiper blade 11. The internal opening 47 may have any shape in cross section, as long as the internal opening 47 can guide the spoiler assembly 18 to move relative to the wiper blade 11 along the longitudinal axis X and restrain movement of the spoiler assembly 18 relative to the wiper blade 11 along the vertical direction. The shape of the internal opening 47 includes but is not limited to circular, square, rectangular, triangular, T-shape, H-shape, and irregular shape, among others.

The base portion 40 includes an upper horizontal wall 48 and two side walls 44 extending downwardly from opposing ends 43 of the upper horizontal wall 48. The side walls 44 each include a flange 46. The internal opening 47 is defined by the flange 46 and the upper horizontal wall 48. The internal opening 47 has a shape substantially matching the outer profile of the mounting piece 34. The two side walls 44 each have an extension 50 extending downwardly and abutting against the longitudinal edges 21 of the support element 12. The free ends of the extensions 50 are disposed laterally of the longitudinal edges 21 of the support element 12 and extend below support element 12 to prevent the support element 12 from contacting the windshield.

Referring to FIG. 10, the mounting pieces 34 each include an upper flange 50, two lower flanges 52, and a pair of connecting walls 54 that connect the upper flange 50 and the lower flanges 52. The upper flange 50, the connecting walls 54, and the lower flanges 52 define a head-receiving space 55 therein. The mounting piece 34 is inserted into the internal opening 47 of the spoiler body 38. The lower flanges 52 are inserted into the notches 35 of the wiper strip 14. When the spoiler assembly 18 is mounted on the wiper blade 11, the head 30 of the wiper strip 14 is partially enclosed by the upper flange 50, the connecting walls 54 and the lower flanges 52. The spoiler assembly 18 is mounted to the wiper strip 14 by inserting the head 30 of the wiper strip 14 into the head-receiving space 55 of the mounting piece 34.

The spoiler bodies 38 and the mounting pieces 34 may be made from different plastic materials and may be manufactured (for example, by extrusion) separately and in one extrusion process. The mounting pieces 34 are made from a relatively hard material with higher mechanical/structural strength to increase structural stability of the spoiler assemblies 18. The spoiler bodies 38 are made from a relatively less hard material suitable for wind deflection. To save manufacturing and assembling time, the spoiler bodies 38 and the mounting pieces 34 may be extruded concurrently by the same extruding machine using different materials. The joined spoiler bodies 38 and the mounting pieces 34 as a unit may be mounted to the support element 12 in one single step.

It is understood and appreciated that the spoiler body 38 may include only one material and thus the internal opening 47 of the spoiler body 38 has a shape substantially matching the shape of the head 30 of the wiper strip 14.

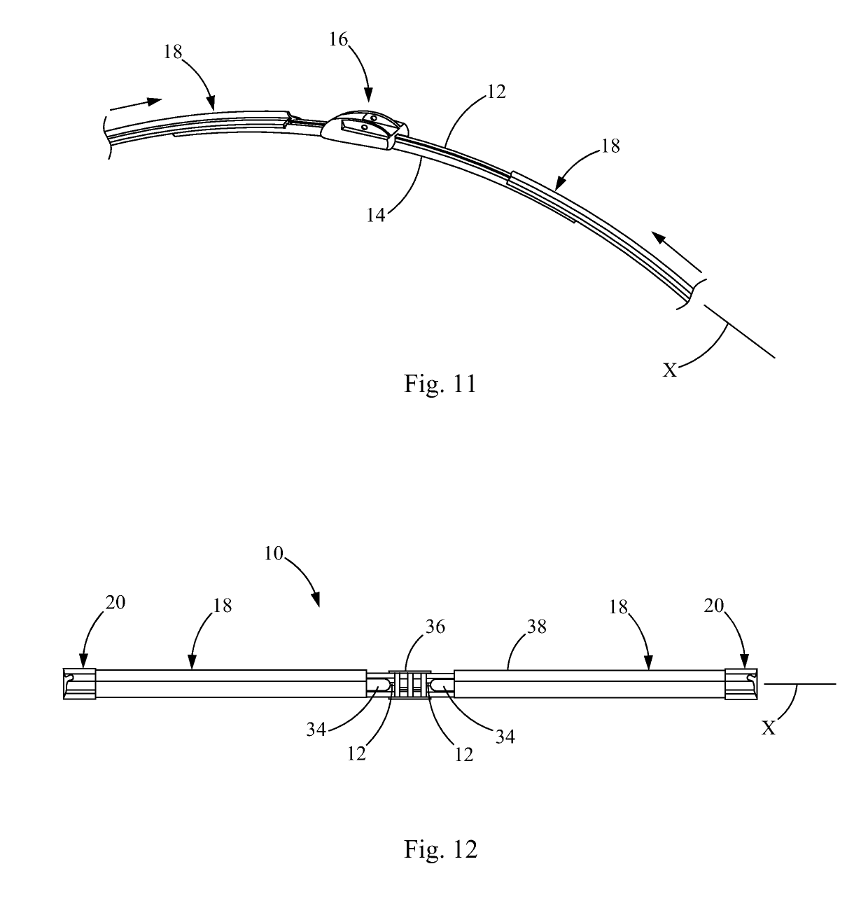

Referring to FIG. 11, to mount the spoiler assemblies 18 to the wiper blade 11, the mounting pieces 34 may be first inserted into the internal opening 47 of the spoiler bodies 38, followed by inserting the head 30 of the wiper strip 14 into the head-receiving space 33 of the mounting pieces 34 along the longitudinal axis X of the wiper blade 11. Alternatively, the mounting pieces 34 may be first slid around the head 30 of the wiper strip 14 along the longitudinal axis X, followed by sliding the spoiler bodies 38 around the mounting pieces 34 toward the center of the wiper blade 11.

As shown in FIG. 12, the mounting pieces 34 are longer than the spoiler bodies 38. Therefore, when the mounting pieces 34 and the spoiler bodies 38 are in position, a portion of the mounting pieces 34 proximate the bridge base 34 is not covered by the spoiler bodies 38. The spoiler bodies 38 define a space therebetween for receiving the adaptor assembly 36. The adaptor assembly 36 defines a cutout 45 to receive a portion of the wind deflection portion 42 adjacent to the bridge base 36. Therefore, the adaptor assembly 36 can be mounted to the wiper blade 11 before or after the spoiler bodies 38 are mounted. When the spoiler assemblies 18 are disposed in place, the end caps 20 may be mounted to the longitudinal ends 19 of the support element 12 to secure the spoiler assemblies 18 on the wiper blade 11.

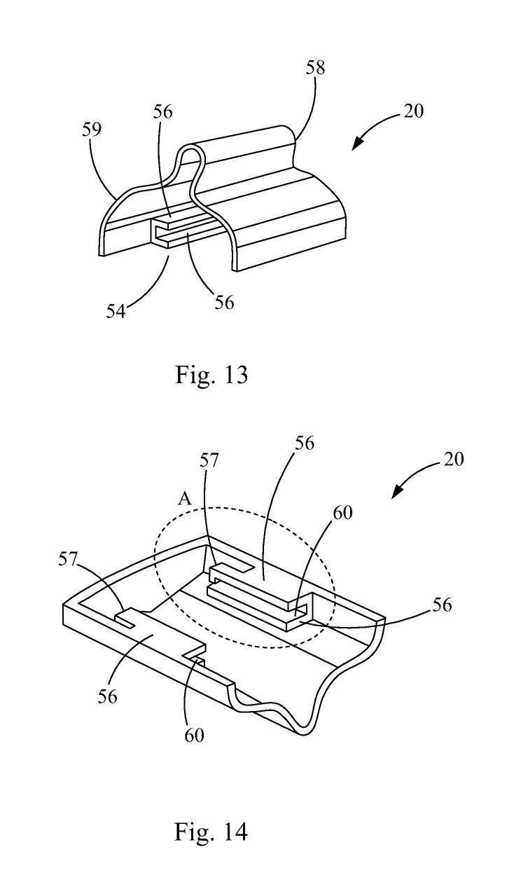

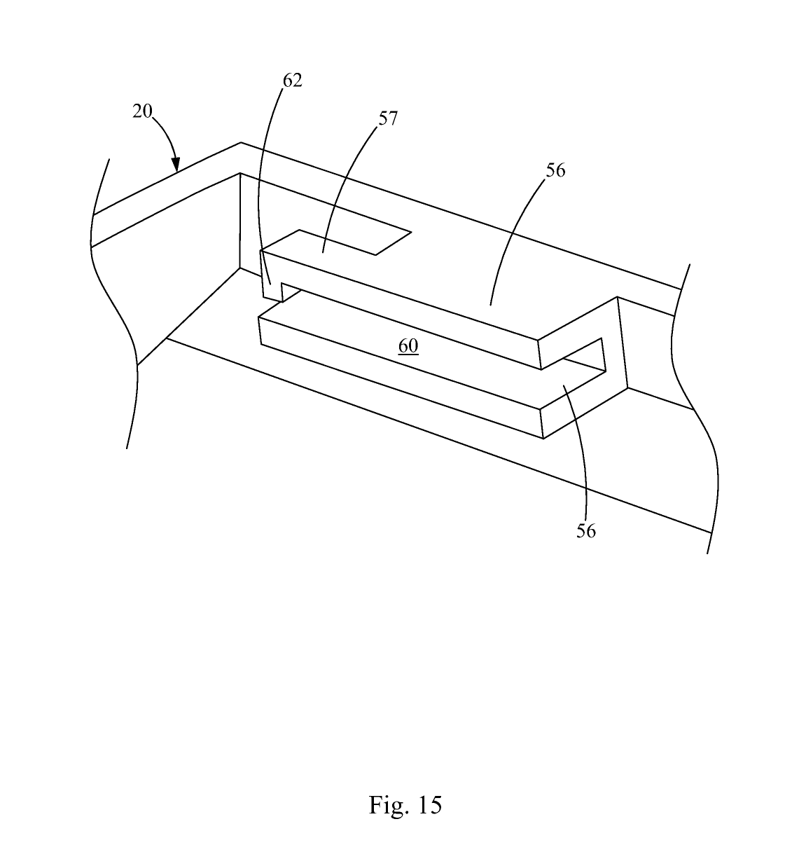

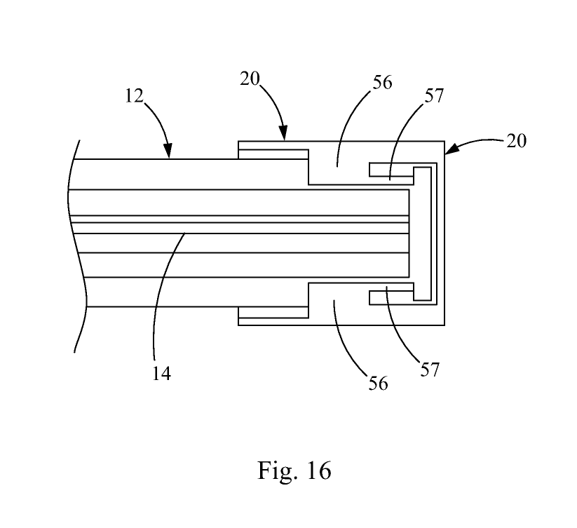

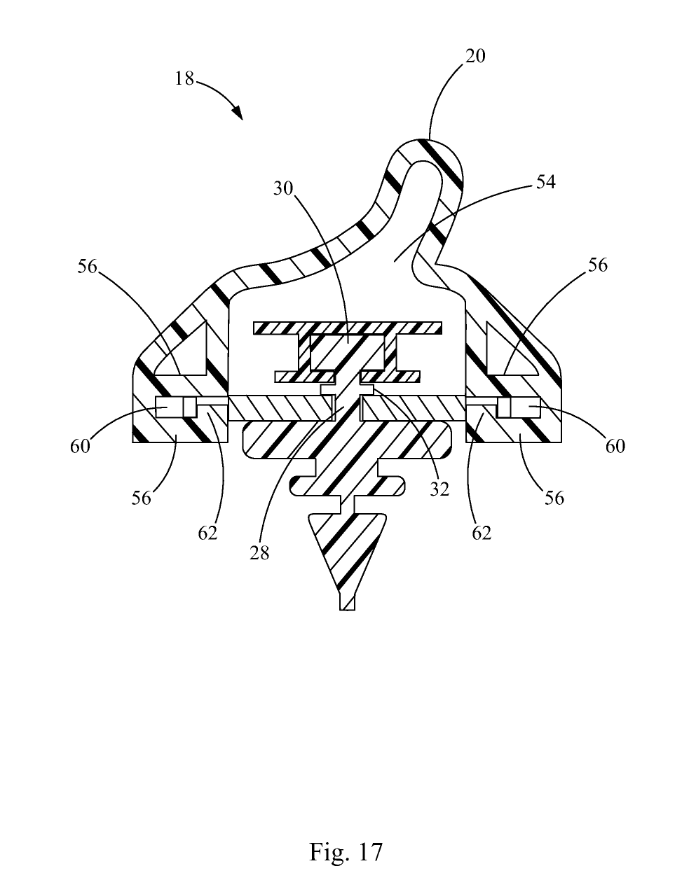

Referring to FIGS. 13 to 17, the end caps 20 each have an outer profile similar to that of the spoiler bodies 38. The end caps 20 have a closed end 58, an open end 59 opposite to the closed end 58, and a hollow space 54 therebetween. When the end caps 20 are mounted to the longitudinal ends 19 of the support element 12, a part of the spoiler assemblies 18 is received in the hollow space 54. A pair of horizontal walls 56 extend horizontally and inwardly from each of the inner side surfaces of the end caps 20. A slot 60 is defined between the pair of horizontal walls 56 for receiving longitudinal edges 21 of the support element 12 therein. The lower horizontal wall 56 defines a finger member 57. The finger member 57 includes a protrusion 62 extending upwardly and perpendicularly from the finer member 57 in the slot 60.

To mount the end caps 20 to the support element 12, the end caps 20 are slid along the longitudinal axis X of the support element 12. The longitudinal edges 21 of the support element 12 are received in the slots 60 of the end caps 20 and bias the protrusions 62 away until the end cap 20 reaches its final position. In the final position, the protrusion 62 is disposed in the cutout 64 of the support element 12 and returns to its unbiased position. The protrusion 62 abuts against an edge of the cutout 64 to prevent the end caps 20 from moving along the longitudinal axis X of the support element 12.

While not shown in the drawings, it is understood and appreciated that the spoiler body 38 may include locking features to engage the support element 12 to further secure the spoiler body 38 to the wiper blade without using an end cap 20.

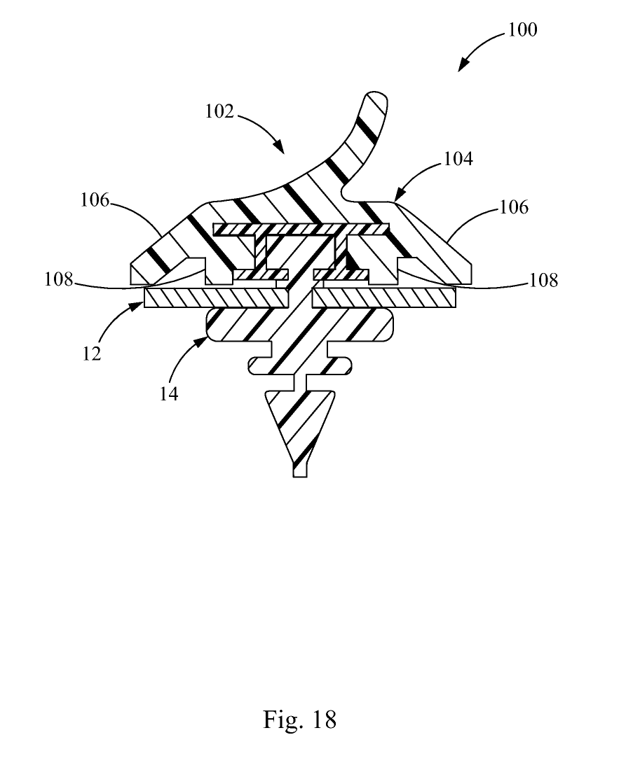

Referring to FIG. 18, a variant of a wiper blade assembly 100 according to the present disclosure is shown. The wiper blade assembly 100 is similar to that shown in FIG. 9 except for the structure of the spoiler body 102. As shown, the spoiler body 102 has a base portion 104 that does not contact the support element 12. Similar to the embodiment in FIG. 9, the base portion 104 includes a pair of side walls 106 and a pair of flanges 108 extending downwardly toward the support element 12. The side walls 106 and the flanges 108, however, are shorter than those in FIG. 9 and do not contact the support element 12.

The spoiler assembly of the present disclosure includes a mounting piece that slidingly mounts the spoiler body to a wiper strip, not the support element. Therefore, the molding tools for the spoiler assemblies can be easily modified to manufacture different spoiler assemblies having different profiles for different types and sizes of wiper blades. The different spoiler assemblies 18 can still use the same mounting pieces to mount the spoiler bodies to the wiper blade. Moreover, the sliding connection between the mounting piece and the head of the wiper strip and between the spoiler body and the mounting piece makes it relatively easy to assemble the spoiler assembly to the wiper blade, thereby saving manufacturing costs. The spoiler assembly is more securely mounted to the wiper blade along the entire length of the spoiler assembly.

This description is merely exemplary in nature and, thus, variations that do not depart from the gist of the disclosure are intended to be included within the scope of the disclosure. Further areas of applicability of the present invention will become apparent from the detailed description provided hereinafter. It should be understood that the description and specific examples, while indicating the preferred embodiments of the invention, are intended for purposes of illustration only and are not intended to limit the scope of this disclosure.

What is claimed is:

1. A wiper blade assembly comprising:
a wiper blade including a wiper strip; and
a spoiler assembly defining a internal opening for receiving a first portion of the wiper strip, wherein the spoiler assembly is slidingly and removably mounted to the wiper blade by inserting the first portion of the wiper strip in the internal opening.

2. The wiper blade assembly of claim 1 wherein the internal opening is adapted to prevent the spoiler assembly from moving along a vertical direction of the wiper blade.

3. The wiper blade assembly of claim 1 wherein the spoiler assembly includes a mounting piece and a spoiler body wherein the spoiler body is removably and slidingly mounted to the first portion of the wiper strip by the mounting piece.

4. The wiper blade assembly of claim 3 wherein the mounting piece is disposed in the internal opening.

5. The wiper blade assembly of claim 4 wherein the mounting piece is disposed between the spoiler body and the first portion of the wiper strip.

6. The wiper blade assembly of claim 3 wherein mounting piece is made of a first material and the spoiler body is made of a second material, wherein the first material has a higher mechanical strength than the second material.

7. The wiper blade assembly of claim 3 wherein the spoiler body includes a base portion proximate the wiper blade and a wind deflection portion distal of the wiper blade, wherein the internal opening is defined in the base portion.

8. The wiper blade assembly of claim 7 wherein the wind deflection portion includes a curved surface.

9. The wiper blade assembly of claim 3 wherein the wiper blade further includes a support element having an upper surface and a bottom surface, wherein the first portion is disposed proximate the upper surface.

10. The wiper blade assembly of claim 9 wherein the first portion of the wiper strip includes a base contacting the upper surface of the support element and a head received in the mounting piece.

11. The wiper blade assembly of claim 10 wherein the base and the head define a notch therebetween for receiving a flange of the mounting piece.

12. The wiper blade assembly of claim 1 further comprising at least one end cap mounted at a longitudinal end of the wiper blade for preventing the spoiler assembly from moving along a longitudinal axis of the wiper blade.

13. The wiper blade assembly of claim 12 wherein the end cap defines a hollow space for receiving a portion of the spoiler assembly therein.

14. A wiper blade assembly comprising:
an elastic spring support element defining an upper surface, a bottom surface, and an elongated slot extending along a longitudinal axis of the support element;
a wiper strip inserted through the elongated slot and including a first portion disposed proximate the upper surface, the first portion including a head and a base that contacts the upper surface, the head and the base defining a notch therebetween;
a mounting piece slidingly mounted around the head of the wiper strip, a portion of the mounting piece being inserted into the notch; and
a spoiler body including a wind deflection portion and a base portion proximate the support element and between the wind deflection portion and the support element, the base portion defining a internal opening for receiving the mounting piece, the wind deflection portion defining a curved surface,
wherein the mounting piece and the spoiler body are made of different materials.

15. A spoiler assembly comprising:
a base portion defining a internal opening therein;
a mounting piece movably received in the internal opening for engaging a wiper strip of a wiper blade; and
a wind deflection portion disposed on the base portion.

16. The spoiler assembly of claim 15 further comprising a mounting piece removably and slidingly received in the internal opening.

17. The spoiler assembly of claim 16 wherein the mounting piece defines a space for receiving a first portion of the wiper strip.

18. The spoiler assembly of claim 15 wherein the mounting piece is made from a first material and the wind deflection portion and the base portion are made of a second material, wherein the first material has a structural strength higher than that of the second material.

19. The spoiler assembly of claim 18 wherein the mounting piece, wind deflection portion and the base portion are formed as an integral unit.

20. The spoiler assembly of claim 15 wherein the wind deflection portion is disposed on a side of the base portion distal of the wiper blade and defines a curved surface.
